(19) United States
(12) Patent Application Publication
(10) Pub. No.: US 2026/0265052 A1
(43) Pub. Date: Sep. 10, 2026

(54) Method and catalysts for plasma-catalytic reforming of methane

(71) Applicant: ENERGO, Loos (FR)

(72) Inventors: Maria MIKHAIL, Lille (FR); Johnny ABBOUD, Lille (FR)

(73) Assignee: ENERGO, Loos (FR)

(21) Appl. No.: 18/843,197

(22) PCT Filed: Mar. 7, 2023
(86) PCT No.: PCT/IB2023/052118

§ 371 Date: Aug. 30, 2024

(30) Foreign Application Priority Data
Mar. 7, 2022 (FR) FR2201960

(51) Int. Cl. C01B 3/40; B01J 23/83

(52) U.S. Cl. CPC C01B 3/40; B01J 23/83; C01B 2203/0238; C01B 2203/0861; C01B 2203/1058; C01B 2203/1082; C01B 2203/1241

(57) ABSTRACT

The present invention relates to a method for converting a gas or a gas mixture comprising methane (CH₄), according to the CH₄ reforming reactions (DRM or SRM), characterized in that it is carried out in the presence of cold plasma and a catalyst, said catalyst comprising a support comprising a mixture of alumina and cerium in a molar ratio comprised between 80/20 and 30/70. It also relates to said catalyst, the method for preparing such a catalyst, as well as use thereof for the conversion of a gas or a gas mixture comprising CH₄, activated by cold plasma, preferably generated by dielectric barrier discharge (DBD), to produce high added-value molecules, like hydrogen, CO, gaseous hydrocarbons, liquid hydrocarbons, aromatics, oxygenated compounds (alcohols, acids, ketones, esters, ethers, aldehydes, etc.), and/or liquid fuels.

### TECHNICAL FIELD

The present invention relates to the field of chemical conversion, in particular the conversion of a gas or a mixture of gases comprising methane (CH₄) to produce high added-value molecules like hydrogen (H₂), carbon monoxide (CO), gaseous hydrocarbons, liquid hydrocarbons, in particular oxygenates (alcohols, acids, ketones, esters, ethers, aldehydes, etc.), aromatics, and also liquid fuels. In particular, the invention relates to a method for converting CH₄ implementing a catalytic system in the presence of a cold plasma. The invention also relates to said catalyst which could be activated by a cold plasma, for example generated by dielectric barrier discharge (DBD), thereby enabling chemical conversion via plasma-catalysis. The invention also relates to a method for preparing such a catalyst and to the use of the catalyst to produce high added-value molecules.

### PRIOR ART

With the strong increase in the energy demand and the impact of fossil fuels on the environment, the search for new energy resources receives increasing attention. Greenhouse gas (GHGs) emissions are a global environmental problem which causes worry about the future health of humans and the sustainable life mode. If the reduction of the GHGs emissions is a major objective that all sectors should put efforts to reach, the recovery of GHGs is an effective strategy for the management of GHGs, in particular in the energy and industrial processes sectors. Methane (CH₄) is a powerful greenhouse gas, which is capable of trapping about 28 times more heat in the atmosphere than carbon dioxide (CO₂), over a period of 100 years. This means that despite its much lower concentration in the atmosphere compared to CO₂, CH₄ significantly contributes to climate change. Hence, reducing or recovering CH₄ emissions is crucial for fighting global warming.

Catalytic reforming of CH₄ is a widely used process in the industry for converting natural gas into H₂ or into synthesis gas (H₂ and CO). It is based on different processes, namely steam reforming of CH₄ (SRM), partial oxidation of CH₄ and dry reforming of CH₄ with CO₂ (DRM).

Most of the H₂ present on the market is nowadays produced in the industry by steam reforming of CH₄ (SRM) according to the equation 1 (Eq. 1). However, steam reforming is highly endothermic. It is typically performed at high temperature (700° C.-1,000° C.), under a pressure in the range of 25 bar, and catalyzed by catalysts based on noble metals.

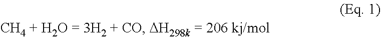

It is possible to implement the low-temperature dry reaction for reforming CH4 in a non-thermal plasma, so-called cold plasma, where the electrons participate in conducting the chemical reactions at low temperature. In the literature, it has been reported that these could take place in microwave plasma reactors, gliding-arc reactors, radiofrequency plasma reactors and DBD reactors [1], [2], [3]. However, the energy efficiency noticed in a DBD plasma coupled with a catalyst is not high enough for an industrial use.

Moreover, the dry reforming of CH₄ (DRM) according to the equation 2 (Eq. 2) receives great interest because of its potential to carry out a sustainable and low carbon emission process in chemical industries and oil refineries and to avoid the drawbacks of storage. The chemical conversion of CH₄ in the presence of CO₂ may be indirect or direct. According to the indirect approach, which has been the subject-matter of researches for decades, the mixture of CO₂ and CH₄ is first converted into synthesis gas products, a mixture of hydrogen (H₂) and carbon monoxide (CO). Afterwards, the synthesis gas may be converted into liquid fuels and other oxygenated chemical products by the Fischer-Tropsch FTS process. The direct approach is more interesting, as it allows converting CH₄ in the presence of CO₂ into high added-value synthesis gases and liquid products in one single reaction step.

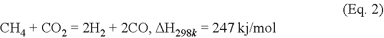

Given the high chemical stability of CO₂ and CH₄, conventional thermal catalysis processes such as dry reforming of CH₄ (DRM) require high gas pressures as well as a large amount of energy (thermal energy), in particular temperatures in the range of 700° C. to 1,000° C., to promote activation of the catalyst, shift the thermodynamic equilibrium and guarantee acceptable yields. High-temperature catalytic reactions not only result in a high energy consumption, but also in a potential deactivation of the catalyst due to sintering of the metallic active sites and the formation of coke at the surface of the catalyst. In general, thermal processes are catalyzed by noble metals, such as Ir, Pd, Pt, Rh and Ru, in stable operation and with relatively small amounts of carbon deposited over the catalysts. As an alternative to noble metals, a catalyst based on Ni, a non-noble metal, which has the advantages of greater availability and lower cost, has been reported as having a relatively high activity for DRM [4].

Different studies have been conducted to develop technologies for chemical synthesis by cold plasma, allowing overcoming the aforementioned temperature problems. Among these technologies, the dielectric barrier discharge (DBD), in particular coupled with the presence of a heterogeneous catalyst (plasma-catalysis), has been described [5], in particular the synergistic effects of the plasma and of the catalysts which lead to better results compared to thermal catalysis [6], [7]. The dielectric barrier discharge (DBD), a type of non-thermal plasma (NTP), is a promising technique used in various reactions. It receives particular attention in the use of CO₂ and CH₄ through the DRM process because of the possibilities of scaling, mild operating conditions, in particular ease of handling, compactness of the system and the versatility of the process.

Different catalytic systems, plasma types, reactors and experimental conditions have been tested to improve the conversion and the selectivity of synthesis gas products. However, the efficiency of these systems is still very low. In addition, the activity, the stability and the costs of the catalysts have turned out to be incompatible with an industrial use. Little effort has been devoted to the direct approach, i.e. the synthesis by plasma-catalysis of liquid chemical products (including hydrocarbons) directly from CO₂ and CH₄ with a considerable selectivity under ambient conditions [8].

Hence, there is a need for a hybrid plasma-catalysis process in the presence of an effective catalyst enabling the conversion reaction of a gas or a mixture of gases comprising CH₄, for example using a hybrid cold plasma-catalysis process, said catalyst enabling a reduction in the energy consumption in the reaction and/or an improvement in the catalytic performances, namely the rate of conversion of the gas, the selectivity and the catalytic stability, the objective being to obtain hydrogen (H₂), gaseous hydrocarbons, liquid hydrocarbons with a long carbon chain, as well as oxygenated compounds, preferably directly (in other words in one single step from CH₄).

An object of the present invention is to provide a method for converting CH₄ which meets these expectations.

The conversion method of the present invention implements a catalytic system in the presence of a cold plasma. The catalytic system that could be activated by cold plasma, comprising in particular a support which is a mixture of alumina and cerium in a molar ratio comprised between 80/20 and 30/70.

The article by KHOJA, et al. [9], describes the preparation of the catalyst Ni/La₂O₃—MgAl₂O₄ and use thereof for dry reforming of methane via DBD plasma (DRM: Dry Reforming of Methane). This article does not describe a catalyst comprising a support that is a mixture of alumina and cerium.

The article by FOO, et al. [10], describes an alumina-based catalyst (Saint Gobain Nopro, USA) which is impregnated with the following solutions: 5Co-15Ni/80Al₂O₃ et 2.5Ce-5CO-15Ni/77.5Al₂O₃. According to one embodiment, the catalyst may thus comprise cerium. According to this embodiment, the catalyst comprising an alumina-based support may be impregnated afterwards with solutions potentially comprising cerium. Nevertheless, this article does not describe a catalyst in which cerium is found at the level of the support and is present in a molar amount higher than 20%.

The article by NANDINI, et al. [11] describes a catalyst of formula 13.5Ni-2K/10CeO₂—Al₂O₃ whose support consists of alumina and 10 wt. % of cerium and which is co-impregnated afterwards with nickel and potassium. Cf. paragraph 2.1. This article does not describe a catalyst wherein the support is an alumina/cerium mixture wherein cerium is present in a molar amount higher than 20% and which is used in a cold plasma process.

The article by KHOJA, et al. [12] describes the dry reforming of methane (DRM: Dry Reforming of Methane) using a catalyst γ-Al₂O₃—MgO. The use of cerium is not described.

The article by SONG, et al. [13], describes the production of synthesis gas via DBD using a catalyst Ni/γ-Al₂O₃. The use of cerium is not described.

### SUMMARY OF THE INVENTION

A first object of the present invention relates to a method for converting a gas or a mixture of gases comprising methane (CH₄), according to the CH₄ reforming reactions (DRM or SRM), characterized in that it is carried out in the presence of a cold plasma and of a catalyst, said catalyst comprising a support comprising a mixture of alumina and cerium in a molar ratio comprised between 80/20 and 30/70. According to one embodiment, the cold plasma is a plasma generated by dielectric barrier discharge (DBD).

A second object of the present invention is a catalytic system, also so-called catalyst, allowing converting a gas or a mixture of gases comprising methane (CH₄), according to methane reforming reactions (DRM or SRM). This catalytic system, which may, for example, be activated by a DBD plasma, allows solving all of the drawbacks of the prior art present in the thermal process (high Temperature and Pressure) and capable of producing synthesis gas (hydrogen, CO), liquid hydrocarbons, gaseous hydrocarbons, aromatics, oxygenated compounds (in particular alcohols, acids, ketones, esters, ethers, aldehydes), and/or liquid fuels under atmospheric conditions with a high yield compared to the studies described in the prior art.

According to a preferred embodiment, said catalyst comprises:
a support which is a mixture of alumina and cerium in a molar ratio comprised between 80/20 and 30/70;
nickel, and/or
at least one promoter of the alkali metal type, of the alkaline-earth metal type, of the transition metal type and/or of the lanthanide type (including mixtures thereof).

A third object of the present invention relates to a method for preparing such a catalyst.

A fourth object of the present invention relates to the use of the catalyst according to the present invention for the conversion of a gas or a mixture of gases comprising methane (CH₄), according to the CH4 reforming reactions (DRM or SRM), said conversion being carried out in the presence of cold plasma. The conversion of methane in the context of the present invention allows producing high added-value molecules, like hydrogen (H₂), CO, gaseous hydrocarbons, liquid hydrocarbons, aromatics, oxygenated compounds (alcohols, acids, ketones, esters, ethers, aldehydes, etc.), and/or liquid fuels.

The present invention allows overcoming all of the drawbacks of conventional thermal catalysis methods, as described in the prior art, and thus obtaining high catalytic and energy efficiencies, and could thus be exploited on a large scale.

### DESCRIPTION OF THE FIGURES

Other features, aims and advantages of the invention will appear from the following description, which is merely illustrative and non-limiting, and which should be read with reference to the appended drawings:

FIG. 1 PFD functional diagram of a DBD plasma reactor. Plasma catalysis reactor for the dry reforming of methane. FIG. 1 illustrates the experimental device (PFD diagram) used in an example of dry reforming of CH4, DRM, by a DBD plasma process coupled with the catalyst of the present invention.

FIG. 2 GC-FID spectrum of the organic liquid obtained by combining the catalytic system 8Ni5Co2K—CeAl200 (50-50) with the DBD plasma catalytic reactor. FIG. 2 illustrates a GC-FID spectrum of the liquid obtained during the reaction of CH4 and CO2 in a DBD plasma reactor coupled with the catalyst 8Ni5Co2K—CeAl200 (50-50).

FIG. 3 GC-MS spectrum (mass spectrometer) of the organic liquid obtained by combining the catalytic system 8Ni5Co2K—CeAl200 (50-50) with the DBD plasma catalytic reactor. FIG. 3 illustrates a GC-MS spectrum of the liquid obtained during the reaction of CH4 and CO2 in a DBD plasma reactor coupled with the catalyst 8Ni5Co2K—CeAl200 (50-50).

FIG. 4 PFD functional diagram of a DBD plasma reactor. Plasma catalysis reactor for steam reforming of methane. FIG. 4 illustrates the experimental device (PFD diagram) used in an example of steam reforming of CH4, SRM, by a DBD plasma process coupled with the catalyst of the present invention.

[Table 1] Table showing the catalytic activity (i.e. conversion, selectivity) obtained for several catalysts according to the invention and comparative catalysts, tested in DBD plasma, in the methane dry reforming reaction (DRM).

[Table 2] Table showing the catalytic activity (i.e. conversion, selectivity) obtained for several catalysts according to the invention and comparative catalysts, tested in DBD plasma, in the methane steam reforming reaction (SRM).

### Definitions

The expression “comprised between . . . and . . . ” (for example, a range of values) should be understood as including the bounds (for example, the limit values of this range of values).

Any description relating to one embodiment is applicable and interchangeable with all of the other embodiments of the invention.

The expression “and/or” should be understood as meaning “and” and “or”; for example, the expression “A and/or B” should be understood as meaning either A and B, or only A, or only B.

The expression “N, M and/or P” should be understood as meaning “N and/or M and/or P”.

The expression “N, M and P” should be understood as meaning “N and M and P”.

In the case where an element or a component is included in and/or selected from a list of elements or components, it should be understood that this individual element or component may be selected and combined with other individual elements, or may be selected to constitute a subgroup of two or more elements or components explicitly listed; also, any element or component mentioned in a list of elements or components may be omitted from this list.

In the present invention, the term “DBD—Dielectric Barrier Discharge” refers to an electrical discharge created between two electrically-conductive elements separated by one or more dielectric element(s).

In the present invention, the term “dielectric” refers to an electrically-insulating material which allows ensuring electrical insulation between the high-voltage network associated with the electrode and the electrically- and thermally-conductive tube grounded via the reactor. This type of electrically-insulating material is also used inside the DBD cell in order to generate a Dielectric Barrier Discharge (DBD) plasma by promoting the accumulation of electric charges at the surface of this material.

In the present invention, the terms “catalyst” and “catalyst system” are interchangeable and refer to a material promoting the chemical reaction of the reactive species, for example reagent fluids.

In the present invention, the term “plasma-catalysis” refers to the process that implements an electrical discharge of plasma coupled to a catalyst.

In the present invention, the term “support” or “support of the catalyst” refers to a solid material or a mixture of solid materials—which may in particular be characterized by its specific surface area, over which the promoter(s) is(are) deposited.

In the present invention, the term “promoter” or “promoter of the catalyst” refers to a solid material or a mixture of solid materials added at the surface of the support material, generally in small amounts, intended to increase the efficiency and the performances of the catalyst.

The term “hydrogen” should be understood as meaning “hydrogen” or “H₂”.

The term “carbon monoxide” should be understood as meaning “CO”.

The term “syngas” should be understood as meaning “synthesis gas” or “a mixture of H₂ and CO”.

The term “DRM” should be understood as meaning “Dry Reforming of Methane” or “dry reforming of methane” or “reforming of a mixture of the gas containing methane and carbon dioxide”.

The term “SRM” should be understood as meaning “Steam Reforming of Methane” or “reforming of methane with steam” or “reforming of a mixture of the gas containing methane and water vapor”.

The term “methane reforming” or “methane reforming reactions” should be understood as covering both dry reforming of methane (DRM) and steam reforming of methane (SRM).

Of course, the invention is described in the foregoing as example. Of course, a person skilled in the art is able to carry out different variants of the invention yet without departing from the scope of the invention.

### DETAILED DESCRIPTION OF THE INVENTION

### Method for Converting a Gas or a Mixture of Gases Comprising Methane

A first object of the present invention relates to a method for converting a gas or a mixture of gases comprising methane (CH₄), characterized in that it is carried out in the presence of a cold plasma and a catalyst, said catalyst comprising a support comprising a mixture of alumina and cerium in a molar ratio comprised between 80/20 and 30/70, and preferably nickel and optionally at least one promoter. According to one embodiment, the cold plasma is a plasma generated by dielectric barrier discharge (DBD). In particular, the method for converting methane (CH₄) according to the invention is done according to the CH₄ reforming reactions with vapor (DRM or SRM).

According to a first embodiment, the method for converting a gas or a gas mixture according to the present invention comprises methane (CH₄) and water vapor (H₂O). According to this embodiment, the method generates a synthesis gas (i.e. H₂ and CO), liquid oxygenated compounds and/or gaseous hydrocarbons. In particular, the method for converting methane (CH₄) according to this embodiment is done according to the CH₄ reforming reaction (SRM).

According to a second embodiment, the method for converting a gas or a gas mixture according to the present invention comprises methane (CH₄) and carbon dioxide (CO₂). This embodiment aims to produce high added-value molecules from the synthesis gas (H₂, CO), liquid hydrocarbons, gaseous hydrocarbons, aromatics, oxygenated compounds (in particular alcohols, acids, ketones, esters, ethers, aldehydes), and/or liquid fuels. In particular, the method for converting methane (CH₄) according to this embodiment is done according to the dry CH₄ reforming (DRM) reaction.

In the case where a hydrocarbon in the gas form is generated, it preferably consists of ethane, ethene, propane, propene, butane, butene, pentane, hexane or mixtures thereof.

In the case where an alcohol is generated, it preferably consists of methanol, ethanol, propanol, butanol, phenol, isomers and/or mixtures thereof, more preferably methanol or ethanol.

In the case where an acid is generated, it preferably consists of formic acid, acetic acid, propanoic acid, butanoic acid, pentanoic acid, gallic acid or mixtures thereof, more preferably acetic acid.

In the case where an ether is generated, it preferably consists of methyl tert-butyl ether (MTBE), ethyl tert-butyl ether ETBE, cyclic ethers, non-cyclic ethers or mixtures thereof, more preferably MTBE.

In the case where a liquid hydrocarbon is generated, it preferably consists of molecules of aromatic types (benzene, toluene, xylene, etc.), more complex molecules or mixtures thereof, more preferably benzene.

In the case where a liquid fuel is generated, it preferably consists of C7→C15 or mixtures thereof, more preferably diesel C12.

According to the present invention, the method for converting CH₄ is therefore carried out in the presence of a catalyst, as well as a cold plasma, preferably a plasma generated by dielectric barrier discharge (DBD). The synergy of the plasma catalysis in this method shows a great potential for the direct synthesis of high added-value molecules, as demonstrated in the examples. Said catalyst comprises a support comprising a mixture of alumina and cerium in a molar ratio comprised between 80/20 and 30/70. Preferably, such a catalyst also comprises nickel. Optionally, such a catalyst comprises at least one promoter. The catalyst is used in combination with a cold plasma. It should be noted that all of the features described in connection with said catalyst are applicable to the conversion method of the present invention.

According to the present invention, the method for converting a gas or a mixture of gases comprising methane (CH₄), in particular according to the CH₄ reforming reactions (DRM or SRM), is characterized in that it is carried out in the presence of a cold plasma and of a catalyst, said catalyst comprising a support comprising, or consisting essentially of, a mixture of alumina and cerium in a molar ratio comprised between 80/20 and 30/70. Preferably, the catalyst also comprises nickel.

According to one embodiment, the present invention relates to a method for converting a gas or a mixture of gases comprising methane (CH₄) and carbon dioxide (CO₂), characterized in that it is carried out in the presence of a cold plasma and of a catalyst, said catalyst comprising a support comprising, or consisting essentially of, a mixture of alumina and cerium in a molar ratio comprised between 80/20 and 30/70. Preferably, the catalyst also comprises nickel.

According to another embodiment, the present invention relates to a method for converting a gas or a mixture of gases comprising methane (CH₄) and water (H₂O), characterized in that it is carried out in the presence of a cold plasma and of a catalyst, said catalyst comprising a support comprising, or consisting essentially of, a mixture of alumina and cerium in a molar ratio comprised between 80/20 and 30/70. Preferably, the catalyst also comprises nickel.

According to these two embodiments, the catalyst optionally comprises at least one promoter.

In particular, the products obtained according to these conversion processes depend on the molar ratio between CH₄, CO₂ and/or water vapor used to perform the conversion reaction, which ratio could be determined by a person skilled in the art according to the desired products. For example, the decrease in the CO₂/CH₄ ratio results in the generation of CH₃ radicals, thereby promoting the formation of long-chain products, such as ethanol, and reducing selectivity to methanol.

The synergy of the plasma catalysis in this method proves to be effective for the direct synthesis of added-value synthesis gas, chemical products and liquid fuels from CO₂ and CH₄ or the direct synthesis of synthesis gas, chemicals and gaseous hydrocarbons from H₂O and CH₄, as demonstrated in the following examples.

According to an embodiment of the method of the invention, the selected and prepared catalyst is placed between the electrodes of a DBD plasma reactor, enabling the gaseous species to circulate through the catalyst, and is activated by high-voltage electrical discharges (in the range of a few kV) for a time period in the range of a few nanoseconds to a few microseconds. This polarization, combined with adsorption, desorption and the catalyst/gas interaction, results in the formation of the plasma, as well as activation thereof and the production of hydrogen. The electrical energy supplied to the fixed bed in the form of a sinusoidal or pulsed high voltage creates multiple currents on the HV (high voltage) carrier waves, during the positive and negative polarization. These streamers from a few hundred picoseconds to a few tenths of nanoseconds are responsible for the negative or positive polarization of the catalytic sites.

Before the step of converting the gas mixture, the catalyst according to the invention, in the case where its components are in an oxidized form, is advantageously reduced in situ under cold plasma, preferably a DBD plasma, under H₂ as a discharge gas.

During the implementation of the method of the invention, a strong electric field is created, which activates said catalyst, more particularly between the grains of said catalyst or proximate thereto, upstream or downstream of the catalyst, in the gas stream. This strong electric field is typically between 10³ and 10¹⁰ V/m and may vary over time. It enables the ionization of a portion of the gas and the excitation of atoms and molecules present in the gas phase. The walls of the reactor may typically be made of a metal material; alternatively, in the case where a DBD plasma reactor is preferably used for the implementation of the method of the present invention, the walls of the reactor are made of a dielectric material such as quartz, alumina or ceramic. Advantageously, the reactor may be cylindrical shaped. In addition to the creation of a cold plasma state, the created strong electric field is responsible for the negative or positive polarization of the catalytic sites. This polarization induces adsorption and desorption reactions even at low temperature (for example at temperatures lower than 450° C., or lower than 400° C.). Without polarization (conventional process), the working temperature is higher, generally from 700° C. to 1,000° C.

In particular, the reactor comprises at least one inlet enabling supply thereof with the gas to be converted, comprising CH₄ and CO₂, or CH₄ and H₂O in the gas form, and an outlet for discharging the formed products, in the liquid and/or gas form.

According to an embodiment of the method of the invention, the carbon dioxide (CO₂)/methane (CH₄) molar ratio or the water vapor (H₂O)/methane (CH₄) molar ratio in the gas mixture to be converted varies between 1 and 5, for example between 1 and 4, preferably between 1 and 3.

In a variant of the invention, the catalyst of the invention is activated by a DBD plasma by supplying an electric power lower than 30-35 W/g of catalyst (namely the catalytic system present in the reactor, i.e. in the catalytic bed).

Advantageously, the conversion reaction is carried out at a pressure close to or equal to atmospheric pressure (10⁵ Pa), for example at a pressure between 1·10⁴ Pa and 3·10⁵ Pa. The conversion reaction may be carried out under pseudo-adiabatic conditions, i.e. without thermal insulation and without external heating, or under adiabatic conditions, i.e. with thermal insulation and without external heating, or under isothermal conditions, i.e. with thermal insulation and/or external heating. The DBD plasma is generated by applying a voltage between the two electrodes comprised between 1 and 25 kV, preferably between 5 and 20 kV, in particular with a frequency comprised between 1 kHz and 100 kHz. In particular, the gas hourly space velocity (GHSV) is comprised between 1,000 h⁻¹ and 150,000 h⁻¹, preferably less than 100,000 h⁻¹.

Optionally, a cooling system is present between the container intended to receive the products generated by the conversion reaction and the outlet of the reactor so as to condense and remove the liquid products that might be formed during the conversion reaction.

### Catalytic System or Catalyst According to the Invention

A second object of the present invention relates to a catalyst for the conversion of a gas or a mixture of gases comprising methane (CH₄), said conversion being carried out in the presence of a cold plasma and said catalyst comprising a support comprising a mixture of alumina and cerium in a molar ratio comprised between 80/20 and 30/70. In particular, the conversion is carried out according to the CH₄ reforming reactions (DRM or SRM).

Preferably, the catalyst of the present invention does not comprise any noble metal, such as ruthenium (Ru), iridium (Ir), palladium (Pd), platinum (Pt) or rhodium (Rh).

The catalyst of the present invention could be activated by cold plasma, during implementation thereof in the process of the invention.

According to an embodiment of the present invention, said catalyst comprises:
a support which comprises a mixture of alumina and cerium in a molar ratio comprised between 80/20 and 30/70, and
nickel, and
optionally at least one promoter, for example of the alkali metal type, of the alkaline-earth type, of the transition metal type and/or of the lanthanide type, i.e. a promoter comprises at least one chemical element belonging to alkali metals, alkaline-earth metals, transition metals, and/or lanthanides (including mixtures thereof).

According to another embodiment of the present invention, said catalyst consists essentially of:
a support which comprises a mixture of alumina and cerium in a molar ratio comprised between 80/20 and 30/70, and
nickel.
   According to this embodiment, the catalyst does not comprise any promoter.

According to a preferred embodiment, said catalyst consists essentially of:
a support which comprises a mixture of alumina and cerium in a molar ratio comprised between 80/20 and 30/70,
nickel, and
at least one promoter of the alkali metal type, of the alkaline-earth type, of the transition metal type and/or of the lanthanide type, i.e. a promoter comprising at least one chemical element belonging to alkali metals, alkaline-earth metals, transition metals, and/or lanthanides (including mixtures thereof).

The catalytic system is characterized in that the support comprises a mixture of alumina and cerium. According to one embodiment, the support consists essentially of a mixture of alumina and cerium. For example, it comprises cerium-modified alumina.

In the context of the present invention, the terms “catalytic system” and “catalyst” are interchangeable. According to an embodiment of the invention, said catalytic system is so-called mono/bi/tri metallic catalytic system. It should be noted that the concept of monometallic system, bimetallic system and trimetallic system, relates in particular to the species present in the catalyst without taking account of the used support and nickel. For example, in the case where the catalyst is doped with a promoter in addition to nickel, we talk about a monometallic catalyst; in the case where the catalyst is doped with two promoters in addition to nickel, we talk about a bimetallic catalyst; in the case where the catalyst is doped with three promoters in addition to nickel, we talk about a trimetallic catalyst.

In particular, the support used in the context of the present invention is selected for its capacity to adsorb the reagents and more particularly CO₂, for its thermal stability and for its optimized specific surface area intended to promote the plasma-catalyst interface, which allows offering various reaction routes in surface chemistry. It is also selected for its dielectric properties which could affect the properties of the plasma and modify the discharge behavior of the DBD plasma, the electric field and the electron density because of the dielectric permittivity and the polarization effect which gives rise to the local electric field.

According to the present invention, the support of the catalyst comprises, in particular, is formed by of or consists of, a mixture of alumina and cerium. More specifically, the support according to the invention comprises a mixture of alumina and cerium, in particular a mixed oxide AlCe, and the alumina/cerium (Al/Ce) molar ratio is comprised between 80/20 and 30/70. For example, the alumina/cerium (Al/Ce) molar ratio is comprised between 75/25 and 35/65, between 73/28 and 40/60 or between 71/29 and 42/58. For example, the alumina/cerium ratio may be about 70/30±1. According to this embodiment, the Al/Ce molar ratio affects the physicochemical properties (basicity, acidity, reducibility, mobility of oxygen due to the presence of inherent defects present at said surface, etc.) as well as the textural properties (pore volume, pore diameter, specific surface area, etc.) and the electrical properties (permittivity, conductivity, etc.), which, in turn, will modulate the catalytic performances of the system. The Inventors have noted that the presence of cerium in the crystalline networks of alumina allows for a higher number of defects at the surface of the support, which promotes the mobility of oxygen at the surface of said support and thus leads to increased catalytic performances.

According to one embodiment, the support consists of a mixture of alumina oxide, for example Al₂O₃ and of cerium oxide CeO₂.

In the context of the present invention, the alumina may have any specific surface area (expressed on BET surface m²/g). For example, the specific surface area of the alumina is at least 20 m²/g and may in particular vary between 50 and 1,000 m²/g. For example, the specific surface area of the alumina is 200 m²/g or 260 m²/g. According to an embodiment of the present invention, the catalyst comprises a support comprising alumina having a specific surface area varying between 50 and 1,000 m²/g, between 100 and 800 m²/g, between 150 and 300 m²/g or between 180 and 250 m²/g.

In the case where the catalyst comprises nickel, the latter may be in any of its oxidation states and in particular in a metallic form (under its oxidation state 0) or in an oxide form under its oxidation state II (for example, in the form of nickel (II) oxide (NiO)). Advantageously, the mass content of nickel in the catalyst may vary between 0.1% and 50% by weight relative to the weight of the support, for example between 1% and 40% or between 2% and 30%; preferably, it is lower than 25% or lower than 20%. By “weight of the support”, it should be understood “weight of the support comprising the alumina”, including when the support comprises elements other than alumina. In a particularly advantageous manner, the catalytic system comprises about 8%±1% or 10%±1% by weight of nickel relative to the weight of the support.

By convention, a catalyst comprising 8% by weight of nickel relative to the weight of a support comprising alumina and cerium is denoted “8Ni—CeAl”, “8Ni—CeAl” or “8Ni—CeAl”.

According to one embodiment, the present invention relates to a cold plasma-activated catalyst.

The combined use of the catalyst according to the invention and of a cold plasma allows producing high added-value molecules such as hydrogen (H₂), CO and gaseous hydrocarbons, liquid hydrocarbons, in particular oxygenated (alcohols, acids, ketones, esters, ethers, aldehydes, etc.), aromatics as well as heavy fuels like diesel, during the conversion, in particular reforming of the gas comprising CH₄, for example 1/a gas mixture comprising CH₄ and CO₂, and possibly CO and H₂ or for example 2/a gas mixture comprising CH₄ and H₂O, and possibly CO and H₂. The catalytic performances of the reaction are improved, i.e. the conversion rates of CO₂ and/or CH₄ and/or the selectivity to the desired product (liquid fuel and/or synthesis gas). In particular, the catalyst combination according to the invention/cold plasma advantageously allows producing such molecules in one single step from CH₄.

According to one embodiment, the catalytic system according to the present invention does not comprise any promoter. For example, an example of a catalyst according to the invention comprising no promoter is the catalyst Ni—CeAl, i.e. a catalyst comprising a support comprising a mixture of Ce and Al, as well as Ni. More particularly, it may consist of a catalyst 10Ni-CeAl (50-50), i.e. comprising a support with an alumina/cerium (Al/Ce) molar ratio=(50/50) and 10% by weight of Ni relative to the weight of the support CeAl.

According to another embodiment, the catalytic system according to the present invention comprises at least one promoter, i.e. one or more promoter(s). Said at least one promoter acts as a dopant and affects the physicochemical, textural as well as conductive properties of the catalytic system. Advantageously, the promoter according to the invention has suitable surface physicochemical properties to assist in fixing the reagents as well as suitable dielectric properties which allow improving the conductivity of the resulting system and which logically lead to the generation of CH₃ radicals from CH₄, thereby promoting the formation of long carbon chain products (oxygenated species with a long chain and liquid hydrocarbons with particularly long chain).

Thus, in the context of the present invention, the at least one promoter may in particular comprise a chemical element selected from the group consisting of alkali metals, transition metals and alkaline-earth metals, lanthanides and mixtures thereof; more particularly, from the group consisting of alkali metals, such as potassium (K), transition metals such as cobalt (Co), copper (Cu), zinc (Zn), manganese (Mn), yttrium (Y), and iron (Fe), alkaline-earth metals such as magnesium (Mg), lanthanides such as yttrium or lanthanum (La), and mixtures thereof. In the context of the present invention, the promoter is in any one of its oxidation states and in particular in a metallic form or in an oxide form.

In the context of the present invention, the alkali metals may be selected from the group consisting of lithium, sodium, potassium, rubidium, caesium and francium. When the promoter comprises a chemical element which is an alkali metal, the latter is preferably potassium (K) or cesium (Cs), and even more preferably potassium (K).

In the context of the present invention, the transition metals may be selected from the group consisting of copper, cobalt, silver, iron, zinc, manganese, vanadium, manganese, chromium, yttrium, titanium and tantalum. In the case where the promoter comprises a chemical element which is a transition metal, the latter is preferably cobalt (Co) or iron (Fe), and even more preferably cobalt (Co).

In the context of the present invention, the alkaline-earth metals may in particular be selected from the group consisting of magnesium, barium, calcium and strontium. In the case where the promoter comprises a chemical element which is alkaline-earth, the latter is preferably magnesium (Mg).

In the context of the present invention, the lanthanides may be selected from the group consisting of lanthanum, praseodymium, neodymium, promethium, samarium, europium, gadolinium, terbium, dysprosium, holmium, erbium, thulium, ytterbium and lutetium. In the case where the promoter comprises a chemical element which is a lanthanide, the latter is preferably yttrium (Y) or lanthanum (La), and even more preferably yttrium (Y).

According to an embodiment of the present invention, the promoter of the catalyst is selected from the group consisting of potassium (K), cesium (Cs), cobalt (Co), iron (Fe), magnesium (Mg), yttrium (Y), lanthanum (Ia), manganese (Mn) and mixtures thereof. More preferably, the promoter is selected from the group consisting of potassium (K), cobalt (Co), iron (Fe), yttrium (Y) and mixtures thereof.

According to an embodiment of the present invention, the mass content of the promoter in the catalyst varies between 0.1% and 40% by weight relative to the weight of the support, for example between 0.2 and 30% by weight, in particular between 0.5% and 25% by weight, preferably between 1% and 20% by weight, in particular between 1% and 15% by weight, even more preferably between 1% and 9% by weight relative to the weight of the support.

The promoters used for the preparation of the catalysts of the present invention are in any oxidation state, and in particular in a metallic form or in an oxide form. Hence, they could comprise other chemical elements, which are not considered in the calculation of the claimed mass content. For example, for a catalyst 8Ni2K—CeAl, if 1 g of support comprising nickel are used, then 0.051 g of the promoter KNO₃ (molar mass: 101.1 g/mol) are used, which corresponds to 0.02 g of K (molar mass: 39.1 g/mol), i.e. 2% by weight of potassium relative to the weight of the support. For this catalyst, the mass content of the promoter (only one in this example, “K promoter”) is 2% by weight relative to the weight of the support.

The amount of nickel and/or promoter may be adjusted according to the nature of the used promoter and/or the type of conversion reaction implemented, i.e. according to the type of product generated by the conversion reaction, in particular for reforming methane into synthesis gas and/or into hydrocarbons.

According to an embodiment of the present invention, the catalyst according to the present invention is monometallic, i.e. it comprises one single promoter in addition to nickel. In particular, according to a preferred embodiment, the catalyst according to the present invention comprises one single promoter which comprises potassium (K). For example, the potassium chemical element may be brought into the catalyst in the form of a precursor, for example in the form of potassium nitrate KNO₃. More particularly, it may consist of a catalyst 8Ni2K—CeAl (30-70), i.e. comprising a support with an alumina/cerium (Al/Ce) molar ratio=(70/30), 8% by weight of Ni relative to the weight of the support CeAl and 2% by weight of the potassium (K) promoter.

According to an embodiment of the present invention, the catalyst according to the present invention comprises at least two promoters in addition to nickel, i.e. two promoters or more, for example two promoters (it is then bimetallic) or three promoters in addition to nickel (it is then trimetallic).

According to a particular embodiment, the catalyst is bimetallic, doped with two promoters in addition to nickel, wherein one of the two promoters is potassium (K), its mass content in the catalytic system is preferably about 2%±0.2% by weight relative to the weight of the support, while the second cobalt (Co) promoter, its mass content in the catalytic system is preferably about 5%±0.5% by weight relative to the weight of the support. More particularly, it may consist of a catalyst 8Ni5Co2K—CeAl (30-70), i.e. comprising a support with an alumina/cerium (Al/Ce) molar ratio=(70/30), 8% by weight of Ni relative to the weight of the support, 2% by weight of potassium (K) promoter and 5% by weight of cobalt (Co) promoter.

The catalytic system may be in various forms (beads, monoliths, powders, etc.). In the case of powders, the grains forming the powder may for example have an average size comprised between 1 μm and 1 mm, for example between 100 μm and 1 mm, in particular between 200 μm and 800 μm, preferably about 600 μm±20 μm. In particular, the size of the grains may be adapted according to the production scale used. The catalytic system may also be in the form of beads (in particular by compression of the powder in a mold) having an average size smaller than 5 cm.

According to an embodiment of the present invention, the alumina/cerine support, nickel and optionally the promoter(s) form a homogeneous mixture. This means that nickel and the promoter(s) are evenly distributed throughout the volume of the catalyst.

According to a preferred embodiment of the present invention, said catalyst comprises:
a support which comprises a mixture of alumina and cerium in a molar ratio comprised between 80/20 and 30/70, and
nickel, and
at least one promoter selected from the group consisting of potassium (K), cesium (Cs), cobalt (Co), iron (Fe), magnesium (Mg), yttrium (Y), lanthanum (La) and mixtures thereof, preferably potassium (K) or a mixture of potassium (K) and cobalt (Co).

### Method for the Preparation of the Catalytic System

The preparation of the catalytic system according to the present invention may be carried out according to different processes.

According to a first variant, the catalytic system is prepared by bringing the support into contact with a nickel precursor and at least one precursor of the promoter (or of the promoters). This step allows forming a solid comprising the support, nickel and the promoter (or the promoters). This contact step is possibly:
preceded by a step of modifying the support; and/or
followed by a step of calcinating the mixture thus obtained, itself being optionally followed by a step of reducing this calcined mixture.

The calcination step leads to the oxidation of the different components of the catalytic system (support, nickel and promoter). In turn, this optional calcination step may optionally be followed by a reduction step, so as to change the oxidation state of the nickel and of the promoter (to have nickel and a metal promoter), and possibly that of the support. The reduction may be total or partial, i.e. only part of the components of the catalytic system may be reduced. The reduction step may be carried out in situ in the non-thermal plasma device under hydrogen.

The step of bringing the support into contact with a nickel precursor and a precursor of the promoter may be carried out for example by impregnation or by coprecipitation.

The nickel precursor and the precursor of the promoter may be any chemical compound, or mixture of chemical compounds, containing the metal used as an active metal/promoter and more particularly may be a salt of said metal, an oxide of said metal or a mixture thereof, preferably a salt of said metal or a mixture of salts of said metal. For example, the salt (refers to a non-hydrated salt or a hydrated salt, or a multi-hydrated salt) of said metal may be selected from among chloride, nitrate, sulfate, carbonate, acetate, acetylacetonate, tartrate, and citrate of said metal and mixtures thereof, preferably nitrate of said metal. In the case where the promoter is a mixture of several metals, the precursor may be a mixture of different types of salts and/or of oxides of these metals.

According to a first embodiment, the method for preparing the catalytic system comprises a step 1) of preparing a support and a step 2) of bringing the support into contact with a nickel precursor and at least one precursor of the promoter. According to this embodiment, the contact is carried out by impregnation. More specifically, according to this embodiment, the method comprises the following steps:

### 1) Support Preparation:

a) preparation of an aqueous solution comprising a cerium precursor and an alumina oxide or comprising a cerium precursor and an alumina precursor. In step a), the support precursor corresponds to a cerium precursor, an alumina precursor or a mixture of 2 cerium precursors and of an alumina precursor.

In the case where the support is a mixture, in particular a mixed oxide, of cerium and of alumina, a cerium precursor solution and an alumina precursor solution are advantageously prepared separately and then mixed in a ratio allowing obtaining the desired Al/Ce molar ratio in the mixture, in particular the final mixed oxide, of cerium and of alumina.

b) mixing of the suspension resulting from step a). In particular, the addition of these precursors is done at room temperature, in particular from 20 to 25° C. with continuous mixing, in particular from 30 min to several hours, for example from 30 min to 3 h.

c) recovery of the solid obtained in step b) by removal of the excess water, in particular by evaporation of the water or filtration, then drying of the resulting solid. For example, the drying step may be carried out at a temperature lower than 150° C., typically at a temperature of about 100° C., typically for a time period ranging from 7 h to 48 h.

d) calcination of the solid resulting from step c) to give the support.

The product resulting from step c) is then calcined, for example at a temperature comprised between 300° C. and 600° C. This calcination step may be carried out for 3 h or more, for example for a time period ranging from 3 h to 6 h. This step results in the thermal decomposition of the nitrates in order to obtain oxides.

### 2) Contact

a) preparation of an aqueous solution comprising a nickel precursor and one or more precursor(s) of the promoters,

b) addition of the resulting support of 1) to the aqueous solution resulting from step a) to give a suspension,

During step a), an appropriate mass of each precursor is added to an appropriate volume of solvent, for example water. By “appropriate mass” and “appropriate volume”, it should be understood the suitable amounts of precursors and of solvent (in particular water) to obtain the desired mass contents of nickel and of promoter in the final catalytic system.

c) mixing of the suspension resulting from step b),

In particular, the addition of these precursors is done at room temperature, in particular from 20 to 25° C. with continuous mixing, in particular from 30 min to several hours, for example from 30 min to 3 h.

d) recovery of the solid comprising the support, nickel and the promoters obtained in step b) by removal of the excess water, in particular by evaporation of the water or filtration, then drying of the resulting solid. For example, the drying step may be carried out at a temperature lower than 150° C., typically at a temperature of about 100° C., typically for a time period ranging from 7 h to 48 h.

e) calcination of the solid resulting from step d) to give the so-called catalytic system.

The product resulting from step c) is then calcined, for example at a temperature comprised between 300° C. and 600° C. This calcination step may be carried out for 3 h or more, for example for a time period ranging from 3 h to 6 h. This step results in the thermal decomposition of the nitrates in order to obtain oxides.

This first embodiment is also called wet impregnation process. It consists in impregnating the support with the nickel precursor and the precursor of the promoter.

According to a second embodiment, the method for preparing the catalytic system comprises a step of preparing a support and bringing the support into contact with a nickel precursor and the promoter, this contact being carried out by co-precipitation and comprising the following steps:

a′) preparation of an aqueous solution comprising a nickel precursor and the precursors of the promoters (this step is identical to step 2 a) of the wet impregnation process).

b′) addition of the support to the solution resulting from step a′) to give a suspension (this step is identical to step 2 b) of the wet impregnation process).

c′) addition of a base to the suspension resulting from step b′). During this step, a base is added to the suspension resulting from step b′). Advantageously, this base is a hydroxide salt such as sodium or potassium hydroxide or sodium or potassium carbonate, in particular sodium hydroxide. It may be used in the form of a solution, in particular an aqueous solution. The base is progressively added drop-by-drop until the pH of the suspension (consisting of a solid in suspension in a liquid solution) is comprised between 8 and 12, preferably equal to about 10. Advantageously, step c′) is carried out at a temperature comprised between 60° C. and 100° C., in particular between 70° C. and 90° C., preferably equal to about 80° C.

d′) mixing of the suspension resulting from step c′). This step aims to precipitate the nickel hydroxide and the hydroxide of the metal used as a promoter at the surface of the support. Advantageously, mixing, in particular by stirring, is carried out at a temperature comprised between 60° C. and 100° C., preferably equal to about 80° C. This mixing step may be carried out for a time period of 2 h or more, typically for about 3 h.

e′) recovery of the solid comprising the support, nickel and the promoter obtained in step of) and calcination thereof to give the so-called catalytic system (this step is identical to step 2e) of the wet impregnation process).

This method allows precipitating nickel hydroxide and hydroxide of the metal used as a promoter at the surface of the support.

### Use of the Catalyst According to the Present Invention

The present invention also relates to the use of the catalyst, in the presence of cold plasma for the conversion of a gas or a mixture of gases comprising CH₄, according to the CH₄ reforming reactions (DRM or SRM), said catalyst comprising a support which is a mixture of alumina and cerium in a molar ratio comprised between 80/20 and 30/70. According to one embodiment, the cold plasma is a plasma generated by dielectric barrier discharge (DBD).

In particular, the present invention relates to the combined use of the catalyst of the present invention, as well as a cold plasma, for the conversion of a gas mixture comprising methane (CH₄) and water vapor (H₂O), according to the steam reforming reaction (SRM), intended to generate synthesis gas, liquid oxygenated compounds and/or gaseous hydrocarbons.

The present invention also relates to the combined use of the catalyst of the present invention, as well as a cold plasma, for the conversion of a gas mixture comprising methane (CH₄) and carbon dioxide (CO₂), according to the dry reforming reaction of methane (DRM), intended to produce high value-added molecules of the synthesis gas (hydrogen, CO), liquid hydrocarbons, gaseous hydrocarbons, aromatics, oxygenated compounds (in particular alcohols, acids, ketones, esters, ethers, aldehydes), and/or liquid fuels.

Indeed, the Inventors have realized that the combination of a catalyst according to the present invention, and of a cold plasma, preferably a plasma generated by dielectric barrier discharge (DBD), showed an increased efficiency for converting a gas mixture comprising methane according to methane reforming reactions (DRM or SRM).

### LIST OF THE CITED DOCUMENTS

[1] M. Boudjeloud, A. Boulahouache, C. Rabia, N. Salhi, La-doped supported Ni catalysts for steam reforming of methane, International Journal of Hydrogen Energy, Volume 44, Issue 20, 2019, Pages 9906-9913, ISSN 0360-3199, https://doi.org/10.1016/j.ijhydene.2019.01.140.
[2] Qi Wang, Huiliang Shi, Binhang Yan, Yong Jin, Yi Cheng, Steam enhanced carbon dioxide reforming of methane in DBD plasma reactor, International Journal of Hydrogen Energy, Volume 36, Issue 14, 2011, Pages 8301-8306, ISSN 0360-3199, https://doi.org/10.1016/j.ijhydene.2011.04.084.
[3] Xiaobing Zhu, Xiaoyu Liu, Hao-Yu Lian, Jing-Lin Liu, Xiao-Song Li, Plasma catalytic steam methane reforming for distributed hydrogen production, Catalysis Today, Volume 337, 2019, Pages 69-75, ISSN 0920-5861, https://doi.org/10.1016/j.cattod.2019.05.015.
[4] C. Shi, S. Wang, X. Ge, S. Deng, B. Chen, et J. Shen, “A review of different catalytic systems for dry reforming of methane: Conventional catalysis-alone and plasma-catalytic system”, J. CO2 Util., vol. 46, p. 101462, avr. 2021, https://doi.org/10.1016/j.jcou.2021.101462
[5] H. Puliyalil, D. Lasic Jurkovic, V. D. B. C. Dasireddy, et B. Likozar, “A review of plasma-assisted catalytic conversion of gaseous carbon dioxide and methane into value-added platform chemicals and fuels”, RSC Adv., vol. 8, no 48, p. 27481-27508, 2018, https://doi.org/10.1039/C8RA03146K
[6] M. Mikhail et al., “Tailoring physicochemical and electrical properties of Ni/CeZrOx doped catalysts for high efficiency of plasma catalytic CO2 methanation”, Appl. Catal. B Environ., vol. 294, p. 120233, oct. 2021, https://doi.org/10.1016/j.apcatb.2021.120233
[7] M. Mikhail et al., “Electrocatalytic behavior of CeZrOx-supported Ni catalysts in plasma assisted CO2 methanation”, Catal Sci Technol, vol. 10, no 14, p. 4532-4543, 2020, https://doi.org/10.1039/DOCY00312C
[8] A. Wang, J. H. Harrhy, S. Meng, P. He, L. Liu, et H. Song, “Nonthermal plasma-catalytic conversion of biogas to liquid chemicals with low coke formation”, Energy Convers. Manag., vol. 191, p. 93-101, july 2019, https://doi.org/10.1016/j.enconman.2019.04.026
[9] Asif Hussain Khoja, Muhammad Tahir, Nor Aishah Saidina Amin, Process optimization of DBD plasma dry reforming of methane over Ni/La2O3MgAl2O4 using multiple response surface methodology, International Journal of Hydrogen Energy, Volume 44, Issue 23, 2019, Pages 11774-11787, ISSN 0360-3199, https://doi.org/10.1016/j.ijhydene.2019.03.059.
[10] Say Yei Foo, Chin Kui Cheng, Tuan-Huy Nguyen, Adesoji A. Adesina, Kinetic study of methane CO2 reforming on Co—Ni/Al₂O₃ and Ce—Co—Ni/Al₂O₃ catalysts, Catalysis today, Volume 164, Issue 1, 2011, Pages 221-226, ISSN 0920-5861, https://doi.org/10.1016/J.cattod.2010.10.092.
[11] A. Nandini, K. K. Pant, S. C. Dhingra, Kinetic study of the catalytic carbon dioxide reforming of methane to synthesis gas over Ni—K/CeO2-Al2O3 catalyst, Applied Catalysis A: General, Volume 308, 2006, Pages 119-127, ISSN 0926-860X, https://doi.org/10.1016/j.apcata.2006.04.014.
[12] Asif Hussain Khoja, Muhammad Tahir, Nor Aishah Saidina Amin, Cold plasma dielectric barrier discharge reactor for dry reforming of methane over Ni/γ-Al₂O₃—MgO nanocomposite, Fuel Processing Technology, Volume 178, 2018, Pages 166-179, ISSN 0378-3820, https://doi.org/10.1016/j.fuproc.2018.05.030.
[13] Hyung Keun Song, Jae-Wook Choi, Sung Hoon Yue, Hwaung Lee, Byung-Ki Na, Synthesis gas production via dielectric barrier discharge over Ni/γ-Al₂O₃ catalyst, Catalysis Today, Volume 89, Issues 1-2, 2004, Pages 27-33, ISSN 0920-5861, https://doi.org/10.1016/j.cattod.2003.11.009.

### Examples

The invention is now described in more detail with reference to the following examples, whose purpose is illustrative and not intended to limit the scope of the invention.

### A. Preparation of the Different Catalysts by Wet Impregnation

Several supports have been used to prepare various catalysts of Tables 1 and 2 hereinbelow:
1) A commercial alumina oxide (TH, Specific surface area=80 m²/g, Sasol);
2) A commercial alumina oxide (Al200, specific surface area=200 m²/g, Saint Gobain);
3) A commercial alumina oxide (Al260, specific surface area=260 m²/g, Saint Gobain);
4) A commercial silica oxide (Si160, specific surface area=160 m²/g, Saint Gobain);
5) Mixed oxides of Cerium-Aluminum (CeAl) of different molar compositions, synthesized by the Inventors according to the previously-described method.

The catalyst is prepared through two successive impregnation sequences. In other words, a first wet impregnation for the preparation of the alumina support modified by ceria according to the method 1) hereinabove until the calcination step. After calcination, a new step of impregnating only nickel and the promoter(s) this time is carried out on the catalytic system resulting from the first impregnation.

The catalysts with nickel doped by the promoter (metal M) have been prepared by the method from an aqueous solution of Ni(NO₃)₂·6H₂O (Sigma-Aldrich and one or more promoter precursors selected from among: Cu(NO₃)₂·3H₂O, Co(NO₃)₂·6H₂O, Mn(NO₃)₂·4H₂O, La(NO₃)₂·6H₂O, Y(NO₃)₂·6H₂O, Fe(NO₃)₂·9H₂O, Mg(NO₃)₂·6H₂O, Zn(NO₃)₂·6H₂O, NaNO₃, and KNO₃ (all commercially-available, Sigma-Aldrich), depending on the desired promoter.

For example, for the preparation of the catalyst 8Ni5Co2K—CeAl (one of the preferred catalysts of the invention), the nickel content is 8% by weight relative to the weight of the support, that of the promoter Co is 5% by weight relative to the weight of the support and that of the promoter K is 2% by weight relative to the weight of the support. A catalyst 10Ni—CeAl with no promoter has also been prepared as an inventive example according to the present invention.

The appropriate mass of the nickel salt and that of the promoter precursor(s) are dissolved in a volume of water of 50 mL, at room temperature and under stirring. The suitable support mass is added to the aqueous solution containing the mixture of the metal salts and kept under stirring for 2 hours. For example, for the preparation of the catalyst 8Ni5Co2K—CeAl, 0.396 g of nickel nitrate (content 8% by weight), 0.155 g of cobalt nitrate (content 5% by weight), 0.052 g of potassium nitrate (content 2% by weight) and 1 g of the support are mixed according to the previous procedure. The mixture is then placed in a rotary evaporator for 2 h at 65° C., in order to remove the excess water.

After impregnation and evaporation of the water, all samples are collected, dried in an oven at 100° C. for 8 h, then calcined in air at 550° C. for 4 h with a temperature ramp of 10° C./min. After calcination, the samples of the catalytic system are hand-ground and screened to an average grain size comprised between 50 and 200 μm.

The different catalysts prepared according to the above-described method are listed in Tables 1 and 2 hereinbelow.

### B. Conversion of a Gas or a Mixture of Gases Comprising CH₄ in the Presence of the Different Catalytic Systems

### Dry Methane Reforming (PRM) Reaction

The procedure for the production of hydrogen and liquid hydrocarbons by means of a catalytic plasma reactor is as follows: 357 mg of the catalyst to be tested, corresponding to a GHSV (Gas Hourly Space Velocity of 17,000 h⁻¹, are placed between the electrodes of the DBD reactor; the reactor is fed with a mixture of methane and carbon dioxide (50% vol CO₂) with a total flow rate of 120 ml/min STP (Standard Temperature and Pressure) (60 ml/min STP CO₂ and 60 ml/min STP CH₄), at atmospheric pressure and at a temperature of 20° C.

### Steam Methane Reforming (SRM) Reaction

The procedure for the production of hydrogen and gaseous hydrocarbons by means of a catalytic plasma reactor is as follows: 400 mg of catalyst to be tested, and a total flow rate of 150 ml/min STP (Standard Temperature and Pressure) (75 ml/min STP H₂O and 75 ml/min STP CH₄), at atmospheric pressure and at a temperature of 20° C., corresponding to a GHSV (Gas Hourly Space Velocity) of 2,000 h⁻¹, are placed between the electrodes of the DBD plasma reactor; the reactor is fed with a gas mixture containing carbon monoxide and water vapor; the water is propelled first by an inert gas (Ar), then circulates through a mass flow controller, it is then vaporized and mixed with carbon monoxide using a controlled evaporation and mixing system (Bronkhorst CEM). Afterwards, the gas mixture is transported throughout a heated duct up to the inside of the DBD plasma reactor.

A non-thermal dielectric barrier discharge (DBD) plasma has been created between two electrodes: a cylindrical electrode made of copper placed inside a tube made of alumina (3 mm of diameter), surrounded by a coaxial tube made of quartz (10 mm of internal diameter, 1 mm of thickness), and a steel wire wound around the external surface of the tube made of quartz, acting as a ground electrode (grounded via an outer capacitor of 2 nF). In this configuration, a discharge has been sustained in a 2.5 mm space, covering a length of about 1 cm. Before the catalytic test, the catalytic systems as synthesized have been reduced in situ under non-thermal DBD plasma under H₂ as a discharge gas for a time period of 60 minutes.

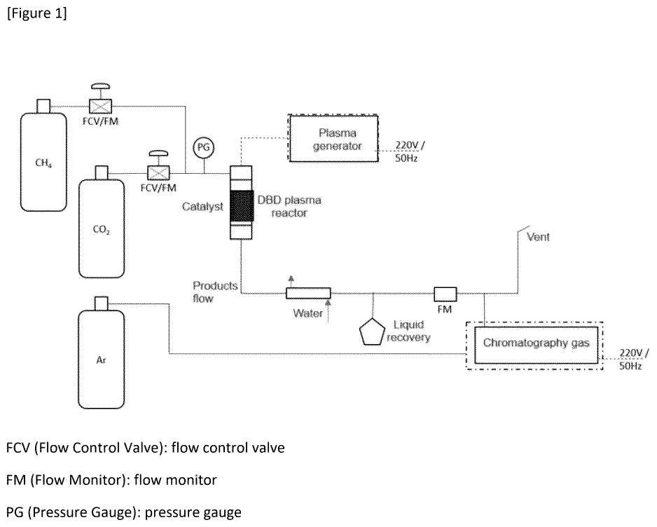

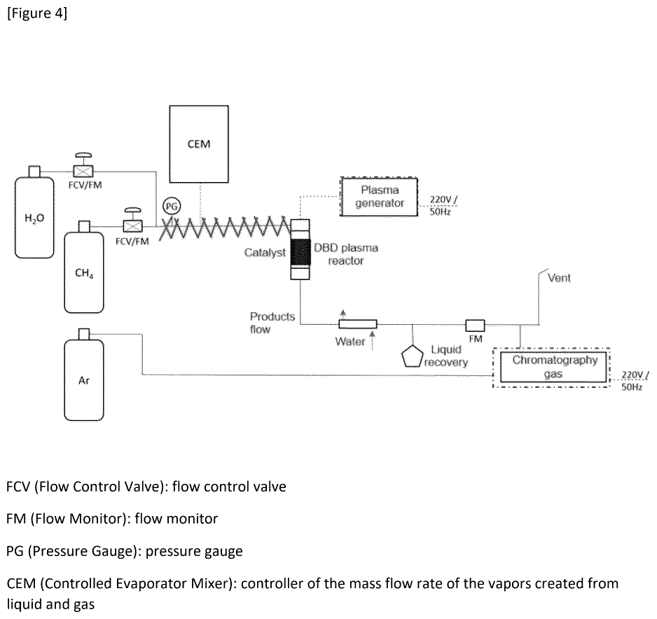

The activity and selectivity of the catalysts with and without the promoter under DBD plasma conditions are assessed in an experimental device comprising a tubular cylindrical reactor made of quartz, a DBD plasma generator, and the corresponding devices for the supply and analysis of the gases. A schematic illustration of the DBD plasma device is provided in FIG. 1 (DRM) and FIG. 4 (SRM).

Without plasma, no modification of the composition of the outlet gases is observed. When the plasma is ignited, and after stabilization, a production of the synthesis gas and of liquid/gaseous hydrocarbons is obtained at the outlet.

The following equations 3 to 8 have been used to estimate the catalytic performance and calculate the conversion of CO₂, the conversion of CH₄, the selectivity of H₂ and CO:

$${X}_{{CO}_{2}} ( \% ) = \frac{{F}_{{CO}_{2}}^{in} - {F}_{{CO}_{2}}^{out}}{{F}_{{CO}_{2}}^{in}} \times 100 \qquad ( Eq . 3 )$$

$${X}_{CH 4} ( \% ) = \frac{{F}_{{CH}_{4}}^{in} - {F}_{{CH}_{4}}^{out}}{{F}_{CH 4}^{in}} \times 100 \qquad ( Eq . 4 )$$

$${S}_{CO} ( \% ) = \frac{{F}_{CO}^{in}}{( {F}_{{CO}_{2}}^{in} - {F}_{{CO}_{2}}^{out} ) + ( {F}_{{CH}_{4}}^{in} - {F}_{{CH}_{4}}^{out} )} \times 100 \qquad ( Eq . 5 )$$

$${S}_{H 2} ( \% ) = \frac{{F}_{H 2}^{in}}{( 2 * ( {F}_{{CH}_{4}}^{in} - {F}_{{CH}_{4}}^{out} ) )} \times 100 \qquad ( Eq . 6 )$$

$${H}_{2} / CO = {S}_{H 2} / {S}_{CO} \qquad ( Eq . 7 )$$

$$Y H 2 ( \% ) = \frac{{F}_{H 2}^{out}}{2 * ( {F}_{{CH}_{4}}^{in} ) + ( {F}_{H 2 O}^{in} )} \times 100 \qquad ( Eq . 8 )$$

for the SRM reaction
where Fⁱⁿ and F^{out} respectively refer to the inlet and outlet flow rate (mol/s) of the considered species at the inlet and at the outlet of the reactor.

### C. Results

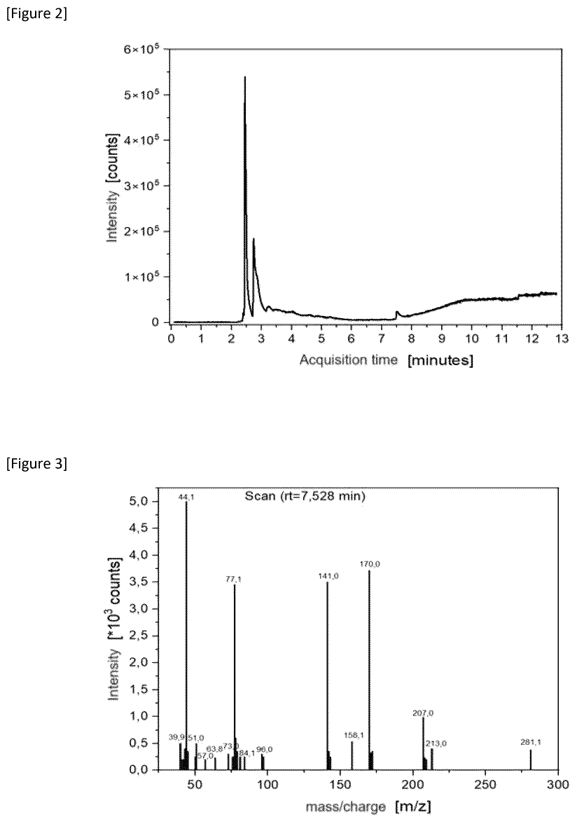

Table 1 hereinbelow indicates the tested catalysts and shows the results of the catalytic activity obtained in terms of conversion, selectivity and yield, from a mixture of gases comprising CH₄ and CO₂ (DRM). FIGS. 2 and 3 show the GC-FID and GC-MS spectra of the organic liquid obtained by combining the catalytic system 8Ni5Co2K—CeAl200 (50-50) with the DBD plasma catalytic reactor, respectively. These figures confirm the presence of acetic acid, acetone, molecules whose Molar Mass=77 g/mol which represents the phenyl group, of molecules with 12 carbons (MM=140 g/mol) and molecules larger than C12 whose MM=207, 213 and 281. The density of this obtained organic liquid is equal to 920 kg/m³.

One could notice that the catalysts 8Ni2K—CeAl200 according to the invention 8i, 13i and 18i, which have an Al/Ce molar ratio in the range 80/20 and 30/70, have a better catalytic yield in CH₄ and CO₂ conversion compared to a catalyst comprising no cerium (8Ni2K—Al200 comparative test 7c), or compared to catalysts comprising cerium outside the claimed molar ratio (comparative tests 17c, 19c and 20c). Indeed, the catalytic yields in CH₄ and CO₂ conversion of the catalysts according to the invention are significantly higher than 50%, while those of the comparative catalysts are all lower than 50%.

Hence, it is necessary to comply with a tradeoff between the molar amount of alumina and cerium at the support of the catalytic system to obtain better conversion yields of CH₄ and CO₂.

Moreover, one could note that the catalyst 8Ni2K—CeAl200 whose Al/Ce molar ratio is lower than 30/70—in the table hereinabove, a molar ratio of 20/80 (test 19c) and a molar ratio of 10/90 (test 20c)—do not enable the production of high value-added liquids.

Although Table 1 hereinbelow does not specify it, the inventive catalysts 5Ni5Co—CeAl200 (30-70) (Al/Ce=70/30) of test 14i and 8Ni5Co2K—CeAl200 (50-50) of test 15i allow producing a large amount of liquids. Hence, these catalysts comprising a cobalt promoter are very efficient for the DRM conversion directly approach in one single step.

Despite its high-performance catalytic results, the catalyst 10Ni5Ce—Al200 of test 3c wherein cerium is not present mixed with the alumina at the support, does not allow obtaining liquids.

TABLE 1

| | | Conversion | | | |
|---|---|---|---|---|---|
| | | CH₄ | CO₂ | | Liquid |
| | Catalyst | (%) | (%) | H₂/CO | production |
| 1c | 5Ni5Co-TH | 31 | 51 | 0.96 | X |
| 2c | 10Ni5Ce-TH | 22 | 71 | — | X |
| 3c | 10Ni5Ce—Al200 | 66 | 59 | 0.78 | X |
| 4c | 10Ni5Ce—Si160 | 21 | 22 | 0.65 | X |
| 5c | 10Ni5Ce—Al260 | 27 | 41 | 0.77 | X |
| 6c | 5Ni5Co—Al200 | 40 | 41 | 0.63 | ◯ |
| 7c | 8Ni2K—Al200 | 31 | 40 | 0.64 | ◯ |
| 8i | 8Ni2K—CeAl200 (50-50) (Al/Ce = 50/50) | 65 | 71 | 0.79 | ◯ |
| 9i | 5Ni5Co—CeAl200 (50-50) (Al/Ce = 50/50) | 57 | 56 | 0.81 | ◯ |
| 10i | 10Ni2K—CeAl200 (50-50) (Al/Ce = 50/50) | 55 | 60 | 0.74 | ◯ |
| 11i | 5Ni5Fe—CeAl200 (50-50) (Al/Ce = 50/50) | 43 | 49 | 0.74 | ◯ |
| 12i | 10Ni2K—CeAl200 (30-70) (Al/Ce = 70/30) | 63 | 68 | 0.76 | ◯ |
| 13i | 8Ni2K—CeAl200 (30-70) (Al/Ce = 70/30) | 78 | 80 | 0.79 | ◯ |
| 14i | 5Ni5Co—CeAl200 (30-70) (Al/Ce = 70/30) | 38 | 41 | 0.63 | ◯ |
| 15i | 8Ni5Co2K—CeAl200 (50-50) (Al/Ce = 50/50) | 26 | 31 | 0.59 | ◯ |
| 16i | 8Ni5Co2K—CeAl200 (30-70) (Al/Ce = 70/30) | 68 | 70 | 0.78 | ◯ |
| 17c | 8Ni2K—CeAl200 (10-90) (Al/Ce = 90/10) | 40 | 47 | 0.74 | ◯ |
| 18i | 8Ni2K—CeAl200 (20-80) (Al/Ce = 80/20) | 63 | 68 | 0.80 | ◯ |
| 19c | 8Ni2K—CeAl200 (80-20) (Al/Ce = 20/80) | 8 | 9 | 0.62 | X |
| 20c | 8Ni2K—CeAl200 (90-10) (Al/Ce = 10/90) | 6 | 11 | 0.58 | X |

Table 2 hereinbelow indicates the tested catalysts and shows the results of the obtained catalytic activity in terms of conversion, selectivity and yield, from a gas mixture comprising CH₄ and H₂O (SRM).

TABLE 2

| | | X_{CH4} | | Gaseous |
|---|---|---|---|---|
| | | conversion | Y_{H2} | hydrocarbon |
| | Catalyst | [%] | yield [%] | production |
| 1′i | 10Ni—CeAl200 (30/70) | 64 | 67 | ◯ |
| 2′i | 15Ni—CeAl200 (30/70) | 41 | 47 | ◯ |
| 3′i | 7Ni3La—CeAl200 (30/70) | 51 | 56 | ◯ |
| 4′i | 10Ni3La—CeAl200 (30/70) | 47 | 52 | ◯ |
| 5′i | 10Ni3Fe—CeAl200 (30/70) | 40 | 45 | ◯ |
| 6′i | 10Ni3Y—CeAl200 (30/70) | 54 | 58 | ◯ |
| 7′i | 10Ni3Co—CeAl200 (30/70) | 51 | 55 | ◯ |
| 8′i | 10Ni3Mg—CeAl200 (30/70) | 45 | 50 | ◯ |
| 9′c | 10Ni—Al200 | 33 | 40 | ◯ |
| 10′c | 10Cu—Al200 | 7 | 14 | ◯ |

1. A method for converting a gas or a mixture of gases comprising methane (CH₄) according to the CH₄ reforming reactions, characterized in that it is carried out in the presence of a cold plasma and a catalyst, said catalyst comprising a support comprising a mixture of alumina and cerium in a molar ratio comprised between 80/20 and 30/70.

2. The method according to claim 1, according to which the catalyst further comprises:
nickel, and/or
at least one promoter selected from the group consisting of alkali metals, alkaline-earth metals, transition metals, lanthanides and mixtures thereof.

3. The method according to claim 2, according to which the at least one promoter is:
of alkali type and more particularly a promoter comprising potassium (K),
of the transition metal type and more particularly a promoter comprising cobalt (Co), copper (Cu), zinc (Zn), manganese (Mn), yttrium (Y), iron (Fe) or mixtures thereof,
of the alkaline-earth type and more particularly a promoter comprising magnesium (Mg), and/or
of the lanthanide type and more particularly a promoter comprising yttrium, lanthanum (La) or mixtures thereof.

4. The method according to claim 2, according to which the mass content of the promoter in the catalytic system varies between 0.1% and 40% by weight relative to the weight of the support, preferably between 0.5% and 25% by weight.

5. The method according to claim 2, according to which the mass content of nickel in the catalytic system varies between 0.1% and 50% by weight relative to the weight of the support, preferably lower than 30%.

6. The method according to claim 1, according to which the cold plasma is generated by dielectric barrier discharge (DBD).

7. The method according to claim 1, for the conversion of a gas mixture comprising methane (CH₄) and carbon dioxide (CO₂) according to the dry methane reforming (DRM) reaction, characterized in that it generates synthesis gas, liquid hydrocarbons, gaseous hydrocarbons, aromatics, oxygenated compounds (in particular alcohols, acids, ketones, esters, ethers, aldehydes), and/or liquid fuels.

8. The method according to claim 1, for the conversion of a gas mixture comprising methane (CH₄) and water vapor (H₂O) according to the steam methane reforming (SRM) reaction, characterized in that it generates synthesis gas, liquid oxygenated compounds and/or gaseous hydrocarbons.

9. A catalyst for the conversion of a gas or a gas mixture comprising methane (CH₄) according to the CH₄ reforming reactions, comprising a support comprising a mixture of alumina and cerium in a molar ratio comprised between 80/20 and 30/70.

10. The catalyst according to claim 9, said catalyst being activated by cold plasma, preferably generated by dielectric barrier discharge (DBD).

11. The catalyst according to claim 10, also comprising:
nickel, and/or
at least one promoter selected from the group consisting of alkali metals, alkaline-earth metals, transition metals, lanthanides and mixtures thereof.

12. The catalyst according to claim 11, according to which the at least one promoter is:
of the alkali type and more particularly potassium; and/or
of the transition metal type and more particularly selected from the group consisting of cobalt, copper, iron, yttrium and mixtures thereof.

13. The catalyst according to claim 11, according to which the mass content of the promoter in the catalytic system varies between 0.1% and 40% by weight relative to the weight of the support, preferably between 0.5% and 25% by weight.

14. The catalyst according to claim 11, according to which the mass content of nickel in the catalyst system varies between 0, 1% and 50% by weight relative to the weight of the support, preferably lower than 30%.

15. (canceled)

16. A process for converting a gas or a mixture of gases comprising methane (CH₄) according to the CH₄ reforming reactions, said conversion being carried out in the presence of a catalyst and in the presence of cold plasma, preferably generated by dielectric barrier discharge (DBD), said catalyst comprising a support comprising a mixture of alumina and cerium in a molar ratio comprised between 80/20 and 30/70.

17. The process according to claim 16, wherein said catalyst also comprises:
nickel, and/or
at least one promoter selected from the group consisting of alkali metals, alkaline-earth metals, transition metals, lanthanides and mixtures thereof.

18. The process according to claim 17, wherein the at least one promoter is:
of the alkali type and more particularly potassium; and/or
of the transition metal type and more particularly selected from the group consisting of cobalt, copper, iron, yttrium and mixtures thereof.
